(19) United States
(12) Patent Application Publication
(10) Pub. No.: US 2011/0009009 A1
(43) Pub. Date: Jan. 13, 2011

(54) PLUG ASSEMBLY WITH IMPROVED STRUCTURE

(76) Inventor: EungHan LEE, Bucheon-city (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/549,463

(22) Filed: Aug. 28, 2009

(30) Foreign Application Priority Data
Jul. 13, 2009 (KR) 10-2009-0063682

(51) Int. Cl. H01R 24/00; H01R 43/00

(52) U.S. Cl. 439/660; 29/876

(57) ABSTRACT

A plug assembly with an improved structure is disclosed. In the plug assembly, the assembling structure between a pin holder constituting a plug and a terminal assembled with the pin holder and allowing electricity to flow through the plug assembly is improved and realizes a reduction in manufacturing cost of the plug assembly and an increase in productivity of the plug assembly. The plug assembly includes a pin holder having locking slots, insert holes, and contact pins; a conductive terminal coupled to the pin holder and having an insert end, protrusions, a contact terminal, a first locking part and a second locking part; and a wire unit having an electric wire gripped by the first locking part through compression so as to apply electricity to the conductive terminal and a covering tube covering the electric wire and gripped by the second locking part through compression.

### BACKGROUND OF THE INVENTION

1. Field of the Invention

The present invention relates to a plug assembly with an improved structure, in which the assembling structure between a pin holder constituting a plug and a terminal assembled with the pin holder and allowing electricity to flow through the plug assembly is improved and realizes a reduction in manufacturing cost of the plug assembly and an increase in productivity of the plug assembly.

2. Description of the Related Art

Generally, as shown in FIG. 1, a conventional plug assembly is produced by preparing both a pin holder 1 having conductive contact pins 7 and 7′ therein and electric wires 6 and 6′, which are covered with respective covering tubes 5 and 5′ and function to apply electricity to the contact pins 7 and 7′, and further by securely coupling the electric wires 6 and 6′ to respective contact pins 7 and 7′ through welding on a PCB 2.

However, the structure of the conventional plug assembly is problematic as follows. To produce the conventional plug assembly, the pin holder 1 and the electric wires 6 and 6′ are produced separately and, thereafter, the electric wires 6 and 6′ are securely coupled to the contact pins 7 and 7′ through welding on the PCB 2. Further, after the welding of the electric wires 6 and 6′ to the contact pins 7 and 7′, an upper cover (not shown) must be coupled to the assembly so as to complete the production process of the plug assembly. Thus, the plug assembly must be produced through a complicated process and, further, when the welded parts are not desirably welded and cause malfunction of the plug assembly, the plug assembly must be disassembled so as to check the welded parts prior to repairing the plug assembly.

### SUMMARY OF THE INVENTION

Accordingly, the present invention has been made keeping in mind the above problems occurring in the structure of the conventional plug assembly related art, and the present invention is intended to propose a one-touch assembled plug assembly with an improved structure, in which a pin holder and conductive terminals assembled with respective electric wires are produced separately and can be assembled with each other into a single body through a simple one-touch action.

In order to achieve the above object, according to one aspect of the present invention, there is provided a one-touch assembled plug assembly with an improved structure, comprising: a pin holder, which comprises a plurality of locking slots provided in upper and lower parts of a body, a plurality of insert holes formed in a front end of the body so as to receive respective conductive terminals therein, and contact pins longitudinally and thoroughly extending through the body so as to be in contact with the conductive terminals and receive electricity from the conductive terminals therethrough; a conductive terminal, which is coupled to the pin holder and comprises an insert end inserted into the insert hole, protrusions provided on upper and lower parts of the insert ends so as to be engaged with the locking slots of the pin holder when the conductive terminal is coupled to the pin holder, a contact terminal in contact with the contact pin of the pin holder so as to apply electricity to the contact pin, a first locking part gripping an electric wire through compression, and a second locking part having a diameter larger than a diameter of the first locking part and gripping a covering tube covering the electric wire; and a wire unit, which comprises an electric wire gripped by the first locking part of the conductive terminal through compression so as to apply electricity to the conductive terminal and a covering tube covering the electric wire and gripped by the second locking part of the conductive terminal through compression.

In the one-touch assembled plug assembly of the present invention, the insert holes of the pin holder may be made of an insulating material and may function as guides for guiding an easy and reliable insertion of the conductive terminals into the pin holder and maintaining a predetermined space between the contact terminals of the conductive terminals and preventing undesired movement of the conductive terminals, thus preventing a short circuit from occurring in the plug assembly.

In the one-touch assembled plug assembly of the present invention, the electric wire covered with the covering tube of the wire unit may be locked to the conductive terminal by the first locking part through compression-gripping, thus applying electricity to the conductive terminal.

In the one-touch assembled plug assembly of the present invention, when the insert end of the conductive terminal is inserted into the pin holder through the insert hole, the protrusions provided in the conductive terminal may be elastically inserted into the insert hole such that the protrusions can be engaged with the locking slots.

According to another aspect of the present invention, there is provided a method of producing a one-touch assembled plug assembly with an improved structure, comprising: preparing a wire unit comprising an electric wire covered with a covering tube; integrating the wire unit with a conductive teminal into a single body by gripping the electric wire and the covering tube with a first locking part and a second locking part of the conductive terminal; and inserting the conductive terminal into a pin holder separately produced from the conductive terminal such that protrusions of the conductive terminal can be engaged with locking slots of the pin holder and a contact terminal of the conductive tenninal can be brought into contact with a contact pin of the pin holder.

As described above, the one-touch assembled plug assembly having improved structure according to the present invention provides the following advantages.

First, to couple the conductive terminals to the pin holder, locking slots are provided in the pin holder and protrusions are provided in the terminals, so that the terminals can be simply and easily coupled to the pin holder through a one-touch assembling process.

Second, the present invention removes a welding process, which has been executed on a PCB in the conventional plug assembly producing process, thus reducing production cost of the plug assembly and increasing productivity of the plug assembly.

Third, the coupling of the terminals to the pin holder in the present invention can be accomplished through a simple inserting process, so that the plug assembly can be easily disassembled and reassembled and can be easily repaired when the plug assembly malfunctions.

### BRIEF DESCRIPTION OF THE DRAWINGS

The above and other objects, features and advantages of the present invention will be more clearly understood from the following detailed description when used in conjunction with the accompanying drawings, in which:

FIG. 1 is a perspective view illustrating a conventional plug assembly;

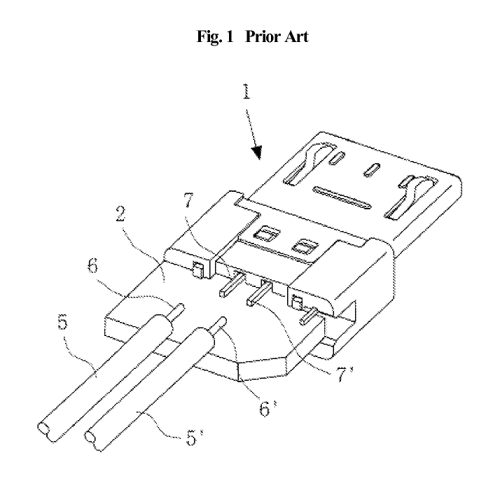

FIG. 2 is a perspective view illustrating a plug assembly according to an embodiment of the present invention;

FIG. 3 is an exploded perspective view illustrating a plug and terminals according to the present invention;

FIG. 4 is a perspective view illustrating an assembled state of a terminal and an electric wire of the present invention;

FIG. 5 is a perspective view illustrating a terminal of the present invention;

FIG. 6 and FIG. 8 are views illustrating states of the plug and terminals of the present invention before the terminals are completely inserted into the plug;

FIG. 7 and FIG. 9 are views illustrating states of the plug and terminals of the present invention after the terminals have been completely inserted into the plug; and

FIG. 10 is a bottom view of FIG. 2 and shows the appearance of the bottom of the plug assembly according to the present invention.

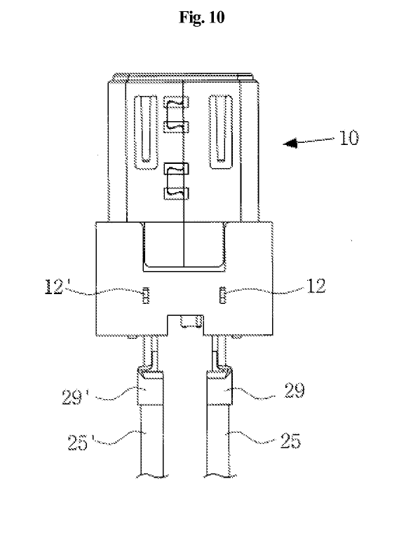

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

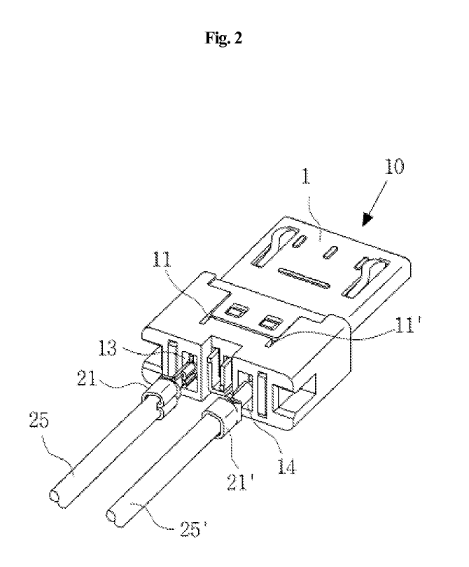

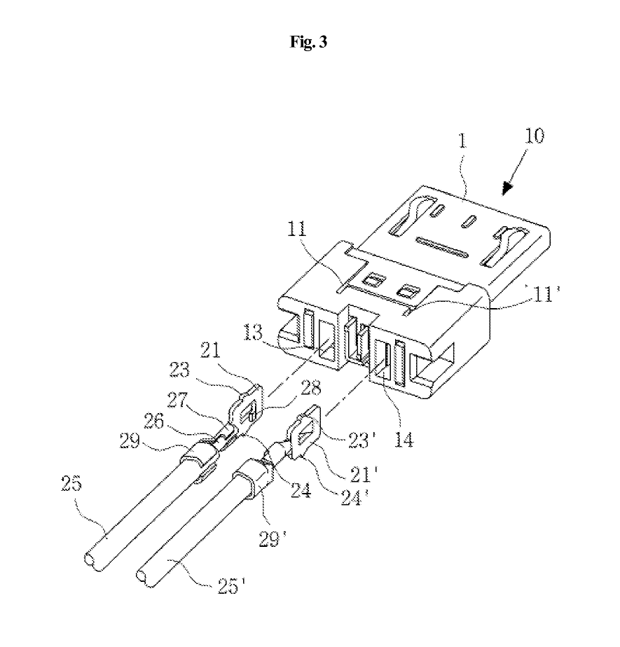

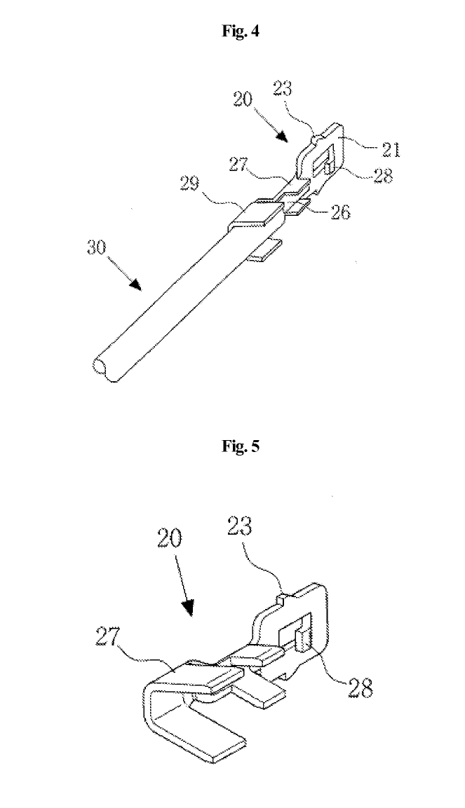

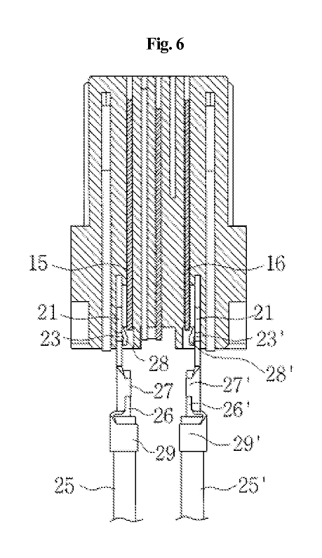

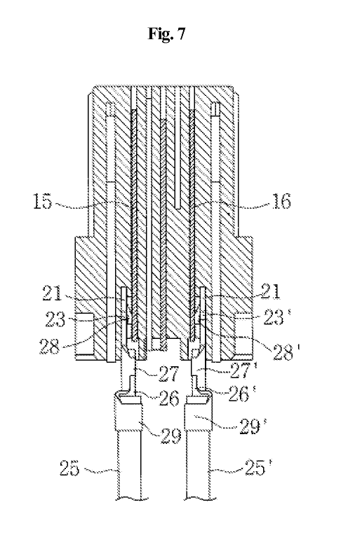

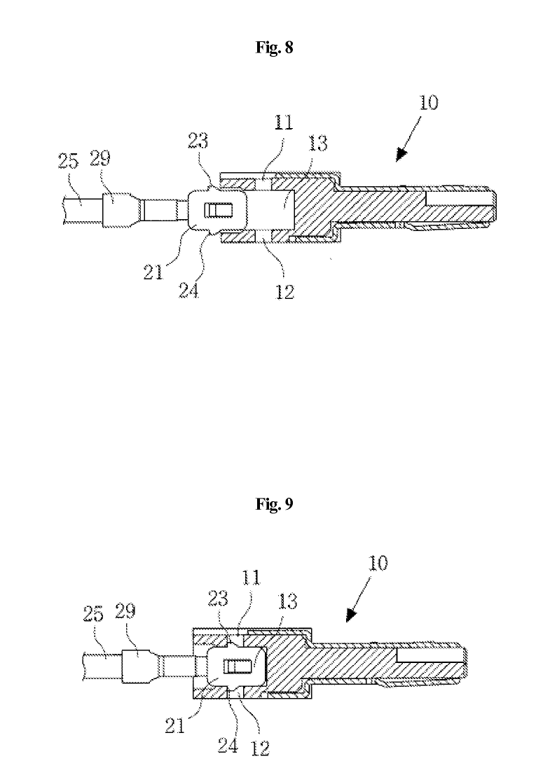

FIG. 2 is a perspective view illustrating a plug assembly according to an embodiment of the present invention. FIG. 3 is an exploded perspective view illustrating a plug and terminals according to the present invention. FIG. 4 is a perspective view illustrating an assembled state of a terminal and a wire of the present invention. FIG. 5 is a perspective view illustrating a terminal of the present invention. FIG. 6 and FIG. 8 are views illustrating states of the plug and terminals of the present invention before the terminals have been completely inserted into the plug. FIG. 7 and FIG. 9 are views illustrating states of the plug and terminals of the present invention after the terminals have been completely inserted into the plug.

As shown in FIG. 2 through FIG. 9, the plug assembly according to the present invention comprises a pin holder 10 (plug), which comprises a plurality of locking slots 11, 12, 11′ and 12′ provided at respective locations in the upper and lower parts of a body 1 covered with a cover (not shown), a plurality of insert holes 13 and 14 formed in a front end of the body 1 so as to receive respective conductive terminals (described in detail later herein) therein, and a plurality of contact pins 15 and 16 longitudinally extending through the body 1 so as to be in contact with the conductive terminals and receive electricity from the conductive terminals therethrough; a conductive terminal 20, which is coupled to the pin holder 10 and comprises an insert end 21, 21′ inserted into the insert hole 13, 14, a plurality of protrusions 23, 24, 23′ and 24′ provided on upper and lower parts of the insert ends 21 and 21′ so as to be engaged with the locking slots 11, 12, 11′ and 12′ of the pin holder 10 when the conductive terminal 20 is coupled to the pin holder 10, a contact terminal 28, 28′ in contact with the contact pin 15, 16 of the pin holder 10 so as to apply electricity to the contact pin, a first locking part 27, 27′ gripping an electric wire (described in detail later herein) through compression, and a second locking part 29, 29′ having a diameter larger than that of the first locking part 27, 27′ and gripping a covering tube covering the electric wire; and a wire unit 30, which comprises an electric wire 26, 26′ gripped by the first locking part 27 of the conductive terminal 20 through compression so as to apply electricity to the terminal 20 and a covering tube 25, 25′ covering the electric wire 26, 26′ and gripped by the second locking part 29 of the terminal 20 through compression.

As described above, the plug assembly of the present invention comprises two conductive terminals 20 having the same construction and two wire units 30 having the same construction. However, in the description, one of the two conductive terminals 20 and one of the two wire units 30 will be described for the sake of description. Further, the cover is provided with holes at locations corresponding to the locking slots 11, 12, 11′ and 12′ formed at predetermined locations in the upper and lower parts of the body 1, so that the engaged states of the protrusions 23, 24, 23′ and 24′ relative to the locking slots 11, 12, 11′ and 12′ can be viewed outside the cover.

The insert holes 13 and 14 of the pin holder 10 function as guides for guiding the easy and reliable insertion of the conductive terminals 20 into the pin holder 10 and maintaining a predetermined space between the contact terminals 28 and 28′ of the conductive terminals 20 and preventing undesired movement of the conductive terminals 20, thus preventing a short circuit from occurring in the plug assembly. Further, the insert holes 13 and 14 are made of an insulating material, thus preventing a short circuit when ground terminals are in contact with the holes.

The contact pins 15 and 16 of the pin holder 10 longitudinally extend the pin holder 10 from the insert holes 13 and 14 such that electricity can flow through the contact pins 15 and 16 to an electric appliance coupled to an electric source by the plug assembly of the present invention.

The electric wires 26 and 26′ covered with the covering tubes 25 and 25′ of the wire units 30 are locked to the insert ends 21 and 21′ of the conductive terminals 20 by the first locking parts 27 and 27′ through compression-gripping, thus applying electricity to the insert ends 21 and 21′. Further, the contact terminals 28 and 28′ provided in the insert ends 21 and 21′ of the conductive terminals 20 are inserted into the pin holder 10 through the insert holes 13 and 14 such that the contact terminals 28 can be brought into secure contact with the contact pins 15 and 16.

Further, when the insert ends 21 and 21′ are inserted into the pin holder 10 through the insert holes 13 and 14, the protrusions 23, 24, 23′ and 24′ provided in the conductive terminals 20 are elastically inserted into the insert holes 13 and 14 such that the protrusions 23, 24, 23′ and 24′ can be engaged with the locking slots 11, 12, 11′ and 12′.

The above-mentioned plug assembly according to the present invention is assembled as follows. When the wire units 30 each comprising the electric wire 26, 26′ covered with the covering tube 25, 25′ are prepared, the electric wires 26 and 26′ and the covering tubes 25 and 25′ are gripped by the first locking parts 27 and 27′ and the second locking parts 29 and 29′ of the conductive terminals 20, thus integrating the terminals 20 with the wire units 30 into terminal assemblies. Thereafter, two tenninal assemblies are inserted into a pin holder 10 separately produced from the terminal assemblies, thus completely producing a plug assembly.

The process for assembling the plug assembly of the present invention is clearly shown in FIG. 6 through FIG. 9.

As shown in FIG. 6, to couple the conductive terminals 20, integrated with the electric wires 26 and 26′ covered with the covering tubes 25 and 25′, to the pin holder 10, the terminals 20 are arranged such that the protrusions 23, 24, 23′ and 24′ can be oriented upwards and downwards.

Thereafter, the insert ends 21 and 21′ of the terminals 20 are inserted into the insert holes 13 and 14 of the pin holder 10, so that the contact terminals 28 and 28′ can be inserted into the central part inside the pin holder 10 while being in contact with the contact pins 15 and 16. In the drawings, the insert ends 21 and 21′ are shown in a state in which they have not reached the central part of the pin holder 10, and are shown in a state in which they have been slightly inserted into the insert holes 13 and 14.

The above-mentioned inserting action is continued until the protrusions 23, 24, 23′ and 24′ formed in the insert ends 21 and 21′ of the terminals 20 are completely engaged with the locking slots 11, 12, 11′ and 12′ of the pin holder 10. In other words, when the protrusions 23, 24, 23′ and 24′ of the terminals 20 are completely engaged with the locking slots 11, 12, 11′ and 12′ of the pin holder 10, the contact terminals 28 and 28′ of the conductive terminals 20 are in contact with the contact pins 15 and 16 provided in the pin holder 10, thus completely assembling the plug assembly into the state in which electricity can flow through the plug assembly.

As shown in FIG. 9, when the protrusions 23, 24, 23′ and 24′ formed in the insert ends 21 and 21′ of the conductive terminals 20 are completely engaged with the locking slots 11, 12, 11′ and 12′ of the pin holder 10, the protrusions 23, 24, 23′ and 24′ are not projected outside the upper ends of locking slots 11, 12, 11′ and 12′ formed in the body 1 of the pin holder 10 because the wall of the body 1 of the pin holder 10 is of a predetermined and substantial thickness.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A one-touch assembled plug assembly with an improved structure, comprising:
a pin holder, which comprises a plurality of locking slots provided in upper and lower parts of a body, a plurality of insert holes formed in a front end of the body so as to receive respective conductive terminals therein, and contact pins longitudinally and thoroughly extending through the body so as to be in contact with the conductive terminals and receive electricity from the conductive terminals therethrough;
a conductive terminal, which is coupled to the pin holder and comprises an insert end inserted into the insert hole, protrusions provided on upper and lower parts of the insert ends so as to be engaged with the locking slots of the pin holder when the conductive terminal is coupled to the pin holder, a contact terminal in contact with the contact pin of the pin holder so as to apply electricity to the contact pin, a first locking part gripping an electric wire through compression, and a second locking part having a diameter larger than a diameter of the first locking part and gripping a covering tube covering the electric wire; and
a wire unit, which comprises an electric wire gripped by the first locking part of the conductive terminal through compression so as to apply electricity to the conductive terminal and a covering tube covering the electric wire and gripped by the second locking part of the conductive terminal through compression.

2. The one-touch assembled plug assembly as set forth in claim 1, wherein the insert holes of the pin holder are made of an insulating material and function as guides for guiding an easy and reliable insertion of the conductive terminals into the pin holder and maintaining a predetermined space between the contact terminals of the conductive terminals and preventing undesired movement of the conductive terminals, thus preventing a short circuit from occurring in the plug assembly.

3. The one-touch assembled plug assembly as set forth in claim 1, wherein the electric wire covered with the covering tube of the wire unit are locked to the conductive terminal by the first locking part through compression-gripping, thus applying electricity to the conductive terminal.

4. The one-touch assembled plug assembly as set forth in claim 1, wherein when the insert end of the conductive terminal is inserted into the pin holder through the insert hole, the protrusions provided in the conductive terminal are elastically inserted into the insert hole such that the protrusions can be engaged with the locking slots.

5. A method of producing a one-touch assembled plug assembly with an improved structure, comprising:
preparing a wire unit comprising an electric wire covered with a covering tube;
integrating the wire unit with a conductive terminal into a single body by gripping the electric wire and the covering tube with a first locking part and a second locking part of the conductive terminal; and
inserting the conductive terminal into a pin holder separately produced from the conductive terminal such that protrusions of the conductive terminal can be engaged with locking slots of the pin holder and a contact terminal of the conductive terminal can be brought into contact with a contact pin of the pin holder.
